(19) United States
(12) Patent Application Publication
(10) Pub. No.: US 2023/0349448 A1
(43) Pub. Date: Nov. 2, 2023

(54) Drive System

(71) Applicant: RENK GmbH, Augsburg (DE)

(72) Inventor: Thomas Stoeckl, Langenmosen (DE)

(73) Assignee: RENK GmbH, Augsburg (DE)

(21) Appl. No.: 18/308,197

(22) Filed: Apr. 27, 2023

(30) Foreign Application Priority Data
Apr. 27, 2022 (DE) 10 2022 204 092.9

(51) Int. Cl. F16H 3/72

(52) U.S. Cl. CPC F16H 3/728

(57) ABSTRACT

A drive system for driving a and/or being driven by a coupled machine comprises an output for driving the and/or by the coupled machine, a first machine unit with at least one electric machine and a second machine unit with at least one electric machine. The first machine unit has a transmission gear and the drive system has a first switching unit which is set up in such a way that, in a first operating state of the first switching unit, it operatively connects the transmission gear of the first machine unit and the output in a torque-transmitting manner and, in a second operating state of the first switching unit, this operative connection is interrupted. In addition or alternatively, the drive system has a first switching device which is set up in such a way that, in a first operating state of the first switching device, the electrical machine of the first or second machine unit and a power supply and/or energy storage device are electrically connected by it, and, in a second operating state of the first switching device, said connection is disconnected and an active short circuit of said electrical machine is effected.

### CROSS-REFERENCE TO RELATED APPLICATIONS

This application claims the benefit of priority under 35 U.S.C. § 119(a) to German Patent Application 10 2022 204 092.9, filed Apr. 27, 2022 (pending), the disclosure of which is incorporated by reference in its entirety.

### TECHNICAL FIELD

The present invention relates to a drive system for driving a coupled machine and/or for being driven by a coupled machine, a machine system including the drive system and the coupled machine, and a method for operating the machine system.

### BACKGROUND

So-called multi-motor drives are known from in-house practice, in which several electric motors jointly drive an output for driving a coupled driven machine. In this way, small electric motors can also be used to drive machines with high input powers.

### SUMMARY

The object of the present invention is to improve the drive from a machine and/or by a machine.

The task is solved by a drive system, a machine system with a drive system, or a method for operating a machine system as described herein.

According to one embodiment of the present invention, a drive system comprises an output, in particular a collective output, in one embodiment a collective transmission, which in at least one operating state drives a coupled machine, which (at least then or in this operating state) functions or is operated as (coupled) working machine, and/or in at least one operating state is driven by this and/or another coupled machine, which (at least then or in this operating state) functions or is operated as (coupled) prime mover, or is arranged or used for this purpose. In the first case, the output represents an output of the drive system (to the coupled machine), in the latter case an output of the coupled (prime mover) machine (to the drive system), it is therefore uniformly referred to as output for more compact representation.

In one embodiment, the output has at least one collective gear and/or at least one (output) shaft, in particular coupled thereto. In one embodiment, this can improve the structure and/or operation, in particular the installation space and/or efficiency, of the drive system.

According to one embodiment of the present invention, the drive system comprises a first machine unit having at least one (first) electric machine and a second machine unit having at least one (second) electric machine.

In one embodiment, the (first) electric machine of the first machine unit drives the output in a motor operating state of this first electric machine or is used for this purpose or is set up for this purpose. Additionally or alternatively, in one embodiment, the (second) electric machine of the second machine unit drives the output in a motor operating state of this second electric machine, or is used or set up for this purpose. Additionally or alternatively, in one embodiment, the (first) electric machine of the first machine unit is driven by or is used by or is set up for the output in a regenerative operating state of this first electric machine. Additionally or alternatively, in one embodiment, the (second) electric machine of the second machine unit is driven by or is used by or is set up for the output drive in a regenerative operating state of this second electric machine.

In a further development, the drive system has one or preferably several further machine units, each with at least one (further) electric machine.

In one embodiment, in the case of the or one or more of the further machine unit(s), their respective at least one further electrical machine in a motor operating state of the respective further electrical machine in each case drives the output or is used for this purpose or is set up for this purpose. Additionally or alternatively, in one embodiment, in the case of the or one or more of the further machine unit(s), their respective at least one further electrical machine in a regenerative operating state of the respective further electrical machine is in each case driven by or by the output, or is used for this purpose, or is set up for this purpose.

In this way, large drive powers or electrical outputs can also be realized or implemented advantageously with relatively small electrical machines.

In one embodiment, the first and second electric machines and/or the first and at least one further electric machine and/or the second and at least one further electric machine have the same rated power. In one embodiment, this allows these electric machines to be used alternately in part-load operation and thus to be spared.

In one embodiment, the first and second electric machine and/or the first and at least one further electric machine and/or the second and at least one further electric machine each have different rated outputs. In this way, particularly suitable electric machines can be used in a targeted manner in part-load operation in one embodiment, thereby improving the efficiency.

According to a first aspect of the present invention, the first machine unit comprises a (first) transmission gear which is at least temporarily driven by the (first, in particular motor-driven) electric machine of the first machine unit and/or at least temporarily drives the (first, in particular generator-driven) electric machine of the first machine unit, and the drive system (comprises) a first, in one embodiment mechanical, switching unit (arranged) such that
in a first operating state of the first switching unit, the transmission gear of the first machine unit and the output are operatively connected in a torque-transmitting manner; and
in a second operating state of the first switching unit, this effective connection between the transmission gear of the first machine unit and the output is interrupted.

In a further development of this first aspect, the second machine unit has a (second) transmission gear, which is at least temporarily driven by the (second, in particular motor-driven) electric machine of the second machine unit and/or at least temporarily drives the (second, in particular generator-driven) electric machine of the second machine unit or is used or set up for this purpose, and the drive system (has) a second, in one embodiment mechanical, switching unit (which) is set up in such a way that
in a first operating state of the second switching unit, the transmission gear of the second machine unit and the output are operatively connected in a torque-transmitting manner; and
in a second operating state of the second switching unit, this effective connection between the transmission gear of the second machine unit and the output is interrupted.

In one embodiment, the or one or more of the further machine unit(s) each has (have) (a) (further) transmission(s) which is (are) at least temporarily driven by the (further, in particular motor-driven) electric machine of the (respective) further machine unit(s) and/or at least temporarily drives or is (are) used to drive the (further, in particular generator-driven) electric machine of the (respective) further machine unit(s) is/are used or set up for this purpose, and the drive system (comprises) one or preferably a plurality of further, in one embodiment mechanical, switching unit(s) which is/are set up in such a way that
in a first operating state of the (respective) further switching unit, the transmission gear of the or one of the further machine unit(s) and the output are operatively connected in a torque-transmitting manner; and
in a second operating state of this further switching unit, this effective connection between the transmission gear of this further machine unit and the output is interrupted.

In one embodiment, each of several further machine units is thus bijectively associated with one (or more) further switching unit(s) by means of which, in a first operating state of the respective further switching unit, the transmission gear of the associated further machine unit(s) and the output are operatively connected in a torque-transmitting manner and, in a second operating state of this further switching unit, this operative connection between the transmission gear of this associated further machine unit(s) and the output is interrupted.

In one embodiment, this allows (gear) elements of the machine unit(s), in a further embodiment those that have higher speeds during operation, to be temporarily decoupled when not required, in the event of a defect or the like, thereby reducing in particular friction losses through or on these elements or their bearings and thus improving the operation, in particular the efficiency, of the drive system. Preferably, fast(er) and/or compact(er) electric machines can be used in this way and thus the structure, in particular installation space, can be reduced, while still keeping friction losses low. Additionally or alternatively, in one embodiment, safety can be increased by interrupting the active connection between these elements and the output in the event of a fault.

According to a second aspect of the present invention, the drive system comprises, additionally or alternatively to the aforementioned first aspect of the switching unit(s), a first, in particular electrical, switching device, which is arranged such that, by means thereof.

i)
in a first operating state of the first switching device, the electric machine of the first machine unit and a power supply (or energy supply) and/or energy storage device are electrically connected; and
in a second operating state of the first switching device, this connection to the power supply and/or energy storage device is disconnected and an active short circuit of this electric machine of the first machine unit is effected, in particular becomes effected; or

ii)
in a first operating state of the first switching device, the electric machine of the second machine unit and a power supply and/or energy storage device are electrically connected; and
in a second operating state of the first switching device, this connection to the power supply and/or energy storage device is disconnected and an active short circuit of this electric machine of the second machine unit is effected, in particular becomes effected.

In a further embodiment of this second aspect, the drive system comprises a second, in particular electrical, switching device which is arranged such that, by means thereof.

in the above case i)
in a first operating state of the second switching device, the electric machine of the second machine unit and a power supply and/or energy storage device are electrically connected; and
in a second operating state of the second switching device, this connection to the power supply and/or energy storage device is disconnected and an active short circuit of this electric machine of the second machine unit is effected, in particular becomes effected; or

in the above case ii)
in a first operating state of the second switching device, the electric machine of the first machine unit and a power supply and/or energy storage device are electrically connected; and
in a second operating state of the second switching device, this connection to the power supply and/or energy storage device is disconnected and an active short-circuit of this electric machine of the first machine unit is effected, in particular becomes effected.

In one embodiment, the drive system comprises one or preferably several further, in particular electrical, switching device(s) which is/are set up in such a way that, by means of them, the following can be achieved
in a first operating state of the (respective) further switching device, the electric machine of the or one of the further machine unit(s) and a power supply and/or energy storage device are electrically connected; and
in a second operating state of this further switching device, this connection to the power supply and/or energy storage device is disconnected and an active short circuit of this electrical machine of the further machine unit is effected, in particular is effected.

In one embodiment, each of a plurality of further machine units is thus bijectively assigned one (of the) further switching device(s), by means of which, in a first operating state of the respective further switching device, the electric machine of the assigned (of the) further machine unit(s) and an power supply and/or energy storage device are electrically connected and, in a second operating state of said further switching unit, this connection to the power supply and/or energy storage device is disconnected and an active short-circuit of this electric machine is effected by the further machine unit, in particular becomes effected.

Empty rotating electrical machines can induce a voltage at their terminals. With a so-called active short circuit (in German: “aktiver Kurzschluss”; AKS), this voltage induction can be advantageously avoided or reduced in one embodiment. Advantageously, the power dissipation of an emptily dragged electrical machine is low. Therefore, according to the second aspect, in one embodiment, electric machines can advantageously be “switched away” or “dragged along” with low power loss when not required, thereby improving the operation, in particular efficiency, of the drive system. Additionally or alternatively, in one embodiment, safety can be increased by causing an active short circuit in the event of a fault.

The first and second aspects can each be implemented or become implemented alone, they, in particular advantageous further embodiments, are therefore partially explained here independently. Similarly, in one embodiment, the first and second aspects can also be combined with each other, so that the explanations also apply equally to this/these combination(s).

In one embodiment, the first and second aspects are combined, in a further embodiment, by
I) one or more of the machine units mentioned herein (in each case) comprise a transmission gear and the drive system (in each case) comprise a switching unit, wherein in a first operating state of this switching unit this transmission gear and the output are operatively connected in a torque-transmitting manner and in a second operating state of this switching unit this operative connection is interrupted, and in addition the electric machine of this or one or more of said machine unit(s) and a power supply and/or energy storage device(s) are electrically connected in a first operating state of a switching device and in a second operating state of said switching device said switching device disconnects said connection and causes an active short circuit of said electric machine; and/or
II) one or more of the machine units mentioned herein (in each case) have a transmission gear and the drive system (in each case) has a switching unit, wherein in a first operating state of this switching unit this transmission gear and the output are operatively connected in a torque-transmitting manner and in a second operating state of this switching unit this operative connection is interrupted, and in addition one or more other of the machine units mentioned herein (in each case) have no transmission gear and/or no switching unit for interrupting an operative connection of a transmission gear of this machine unit and the output, wherein the electric machine of this or one or more of these other machine units and a power supply and/or energy storage device (in each case) in a first operating state of a switching device are electrically connected by this or these, and in a second operating state of said switching device said switching device disconnects said connection and causes an active short circuit of said electric machine.

In other words, in one embodiment, one or more machine units may be provided having only a transmission gear and a switching unit for interrupting the operative connection between transmission gear and output, without the drive system having (a) switching device(s) for effecting an active short circuit of the electric machine of these machine units. Additionally or alternatively, in one embodiment, (a) switching device(s) for effecting an active short-circuit of an electric machine of one or more machine units can be provided without these machine units comprising a switching unit for interrupting the operative connection between a transmission gear and output, wherein one or more of these machine units each comprise a transmission gear operatively connected to the output in a torque-transmitting manner and/or one or more of these machine units do not comprise such a transmission gear operatively connected to the output in a torque-transmitting manner. Additionally or alternatively, one or more machine units can be provided in one embodiment, which each have a transmission gear and a switching unit for interrupting the active connection between this transmission gear and the output, the drive system comprising one or more switching device(s) for causing an active short circuit of the electric machine of this/these machine unit(s).

By providing or setting up both a switching unit and a switching device for one or more machine units in one embodiment, the switching unit can advantageously interrupt the active connection between the transmission gear unit or the output or the switching device can cause the active short-circuit of the electric machine, in particular optionally and/or in the event of a malfunction of the switching unit. In this way, in one embodiment, safety can be increased or a redundant option for “switching off” the electric machine can be provided. By providing or setting up only one switching device for one or more machine units in one embodiment, but no switching unit for interrupting an active connection between a possibly existing transmission gear and the output, the design effort can be advantageously reduced and/or the drive system can be designed to be compact (or more compact) in one embodiment. By only providing or setting up one switching unit for interrupting an active connection between the transmission gear and the output for one or more machine units in one embodiment, but not providing or setting up a switching device, it is possible in one embodiment to advantageously reduce electrotechnical effort and/or to control the drive system simply(more).

In one embodiment, the drive system is such or arranged that in at least one operating state, preferably a full-load operating state, of the drive system
the first switching unit has its first operating state and/or
the first switching device has its first operating state

in a further embodiment, additionally
the second and/or the or one or more of the further switching unit(s) each has/have its/their first operating state and/or
the second and/or the or one or more of the further switching device(s) each has/have its/their first operating state.

According to one embodiment of the present invention, in a method of operating a machine system described herein in an operating state of a drive system, particularly in a full load operating condition, referred to without limitation of generality as an engine operating condition,
the first switching unit has its first operating state and/or
the first switching device has its first operating state,
in a further embodiment additionally
the second and/or the or one or more of the further switching unit(s) each has/have its/their first operating state and/or
the second and/or the or one or more of the further switching device(s) each has/have its/their first operating state,

whereby

in this operating state of the drive system, the electric machine of the first machine unit and the electric machine of the second machine unit and, if applicable, the electric machine of the further machine unit (jointly) drive the output.

In one embodiment, for switching from this one engine operating state to another engine operating state of the drive system, in particular a partial load operating state, in which one or more of the machine units continues to drive the output, at least one of the switching units is transferred from its first to its second operating state and/or at least one of the switching devices is transferred from its first to its second operating state.

In a further embodiment, for switching from this one or this other engine operating state to an additional engine operating state of the drive system, in particular a part-load operating state, in which one or more of the engine units drive the output, at least one other of the switching units is transferred from its first to its second operating state and/or at least one other of the switching devices is transferred from its first to its second operating state.

Additionally or alternatively, according to one embodiment of the present invention, in a method of operating a machine system described herein in an operating state of the drive system, particularly in a full load operating state, referred to without limitation of generality as a generator operating state,
the first switching unit has its first operating state and/or
the first switching device has its first operating state,

in a further embodiment, additionally
the second and/or the or one or more of the further switching unit(s) each has/have its/their first operating state and/or
the second and/or the or one or more of the further switching device(s) each has/have its/their first operating state,

whereby

in this operating state of the drive system, the electric machine of the first machine unit and the electric machine of the second machine unit and, if applicable, the electric machine of the further machine unit are driven (jointly) by the output.

In one embodiment, for switching from this one generator operating state to another generator operating state of the drive system, in particular a part-load operating state, in which one or more of the machine units are driven by the output, at least one of the switching units is transferred from its first to its second operating state and/or at least one of the switching devices is transferred from its first to its second operating state.

In a further embodiment, for switching from said one or said other generator operating state to an additional generator operating state in which one or more of the engine units are driven by the output, at least one other of the switching units is switched from its first to its second operating state and/or at least one other of the switching devices is switched from its first to its second operating state.

In this way, in one embodiment, a high drive power can advantageously be realized as needed or temporarily for driving the coupled machine, or a high drive power of the coupled machine can be converted into electrical power, in each case advantageously with compact (or more compact) electrical machines.

In one embodiment, one or more of the operating states listed below, in particular partial load operating states, of the drive system are carried out or the drive system is set up for this purpose, without this list being to be understood as exhaustive:
the electric machine of the first machine unit drives the output, the electric machine of the second machine unit does not drive the output, in one embodiment the electric machine of the first machine unit and the electric machine of the further machine unit drive the output together and the electric machine of the second machine unit does not drive the output. For this purpose, first switching unit (if present) exhibits its first operating state, the at least one further switching unit (if present) also exhibits its first operating state. The electric machine of the first machine unit and a power supply and/or energy storage device are electrically connected by the first or second switching device (if present), the electric machine of the further machine unit (if present) and a power supply and/or energy storage device are electrically connected by the further switching device (if present). The second switching unit (if present) has its second operating state and/or an active short circuit of the electric machine of the second machine unit is effected by the first or second switching device (if present).
The electric machine of the first machine unit does not drive the output, the electric machine of the second machine unit drives the output, in one embodiment the electric machine of the second machine unit and the electric machine of the further machine unit drive the output together and the electric machine of the first machine unit does not drive the output. For this purpose, second switching unit (if present) has its first operating state, the at least one further switching unit (if present) also has its first operating state. The electric machine of the second machine unit and a power supply and/or energy storage device are electrically connected by the first or second switching device (if present), the electric machine of the further machine unit (if present) and a power supply and/or energy storage device are electrically connected by the further switching device (if present). The first switching unit (if present) has its second operating state and/or an active short circuit of the electric machine of the first machine unit is effected by the first or second switching device (if present).
The electric machine of the first machine unit is driven by the output, in one embodiment the electric machine of the first machine unit and the electric machine of the further machine unit are jointly driven by the output. For this purpose, first switching unit (if present) has its first operating state, the at least one further switching unit (if present) also has its first operating state. The electric machine of the first machine unit and a power supply and/or energy storage device are electrically connected by the first or second switching device (if present), the electric machine of the further machine unit (if present) and a power supply and/or energy storage device are electrically connected by the further switching device (if present). The second switching unit (if present) has its second operating state and/or by means of the first or second switching device (if present) an electrical connection of the electric machine of the second machine unit to a power supply and/or energy storage device is disconnected and an active short circuit of the electric machine of the second machine unit is effected.
The electric machine of the second machine unit is driven by the output, in one embodiment the electric machine of the second machine unit and the electric machine of the further machine unit are jointly driven by the output. For this purpose, second switching unit (if present) has its first operating state, the at least one further switching unit (if present) also has its first operating state. The electric machine of the second machine unit and a power supply and/or energy storage device are electrically connected by the first or second switching device (if present), the electric machine of the further machine unit (if present) and a power supply and/or energy storage device are electrically connected by the further switching device (if present). The first switching unit (if present) has its second operating state and/or by means of the first or second switching device (if present) an electrical connection of the electrical machine of the first machine unit to a power supply and/or energy storage device is disconnected and an active short circuit of the electrical machine of the first machine unit is effected.

By combining the aforementioned operating states, it is possible in one embodiment to advantageously use certain particularly suitable machine units or electrical machines temporarily in accordance with the situation, in particular as required, and to temporarily not use other machine units or electrical machines, and thus in one embodiment to reduce friction losses through or on (gearbox) elements or their bearings, in particular those running at high speed, and/or in the event of a malfunction to interrupt effective connections to these elements and/or to actively short-circuit electrical machines, and thus to improve the operation, in particular the efficiency and/or the safety, of the drive system.

As mentioned elsewhere herein, in addition to the three machine units listed above (without limiting the generality “first”, “second”, “further”), the drive system can comprise one or more further machine units and corresponding switching units and/or switching devices, whereby in one embodiment advantageously even more operating states can be realized and thus the operation can be (further) improved.

In one embodiment, one or more of the switching units as described herein, i.e. in particular the first and/or the second and/or the one or more of the further switching unit(s), comprise (each) at least one freewheel.

In one embodiment, this can advantageously switch between the first and second operating state of the (respective) switching unit automatically or by corresponding control of the associated electrical machines, thereby reducing installation space and/or expense in one embodiment.

In one embodiment, one or more of the switching units as described herein, in particular the first and/or the second and/or the one or more of the further switching unit(s), have (in each case) at least one selectively or actively switchable coupling, in one embodiment by at least one, in particular hydraulic, pneumatic and/or electric, preferably electromotive and/or electromagnetic, actuator, preferably a positive-locking and/or frictional coupling.

In one embodiment, this can advantageously switch between the first and second operating states of the (respective) switching unit in a targeted and/or desired manner, in one embodiment by appropriate switching of the couplings, thereby improving operation in one embodiment.

In a further embodiment, the or at least one of the optionally or actively switchable clutch(es) comprises at least two coupling elements, in one embodiment gear teeth, in particular gear wheels, which can be brought into and out of engagement with one another, wherein in one embodiment the transmission gear and output are operatively connected by the engaged coupling elements or gear teeth or in a torque-transmitting manner and this operative connection between transmission gear and output is interrupted when the coupling elements or gear teeth are disengaged. In this way, reliable engagement can be achieved in one embodiment.

In a further embodiment, the or at least one of the optionally or actively switchable clutch(es) comprises at least two friction elements which can be brought into and out of contact with one another, wherein in one embodiment the transmission gear and output are operatively connected in a torque-transmitting manner by the friction elements contacting one another and this operative connection between the transmission gear and output is interrupted when the friction elements are (have been) separated from one another. In one embodiment, this makes it possible to achieve smooth engagement and/or compact installation space.

In one embodiment, the drive system comprises a controller that controls one or more of the electrical machines mentioned herein and/or switches one or more of the optionally switchable couplings mentioned herein and/or switches one or more of the switching devices mentioned herein (to their first and/or second operating state) or is set up or used for this purpose, in an embodiment (in each case) on the basis of a, preferably sensor-sensed, state of the drive system and/or of the coupled machine. Accordingly, in one embodiment, one or more of the electrical machines mentioned herein and/or one or more of the optionally switchable couplings mentioned herein and/or one or more of the switching devices mentioned herein are switched (to their first and/or second operating state) on the basis of a, preferably sensory, detected state of the drive system and/or of the coupled machine, in particular in order to operate the drive system in a predetermined operating state selected in one embodiment.

Advantageously, in one embodiment, this allows the drive system to be operated in a predetermined operating state, selected in one embodiment, in a targeted and/or desired manner, in one embodiment by appropriate switching of the couplings or switching devices and/or control of the electrical machines, thereby improving the operation of the machine system in one embodiment.

In one embodiment, one or more of the transmission gears mentioned herein (respectively) comprise one or more spur gears, in particular spur gear stages. Additionally or alternatively, in one embodiment the output comprises one or more spur gears, in particular spur gear stages.

In this way, advantageous gear ratios can be realized in one embodiment and/or the construction effort can be reduced.

Additionally or alternatively, in one embodiment, one or more of the transmission gears described herein (each) comprise one or more planetary gears, in particular one or more single-stage and/or one or more multi-stage planetary gears. Additionally or alternatively, in one embodiment, the output comprises one or more planetary gears, in particular one or more single-stage and/or one or more multi-stage planetary gears.

In one embodiment, this can advantageously reduce the installation space.

In one embodiment, one or more of the transmission gears mentioned herein (in each case) reduce or convert an input speed on the electrical machine side into a lower output speed on the output side or are set up or used for this purpose. In one embodiment, one or more of the transmission gears mentioned herein (in each case) have a primary reduction gear.

In one embodiment, this makes it possible to use fast (or faster) and thus compact (or more compact) electric machines and thus reduce the structure, in particular the installation space, while still keeping friction losses low by temporarily decoupling elements of the machine unit(s), which have correspondingly high speeds during operation, when they are not required and thus reducing friction losses through or on fast-running elements or their bearings, in particular, and thus improving the operation, in particular the efficiency, of the drive system.

In one embodiment, one or more of the transmission gears mentioned herein (respectively) increase or convert an electrical machine-side input speed to or into a higher output-side output speed or are set up or used for this purpose.

In this way, in one embodiment, advantageously fast(er) running coupled machines and/or advantageously output drives with higher speeds can be operated.

In one embodiment, one or more of the switching devices in its/their second operating state short-circuit, or are arranged to short-circuit, terminals of the corresponding or associated electrical machine, thereby actively short-circuiting that electrical machine.

Additionally or alternatively, one or more of the switching devices comprise power electronics, in a further embodiment power electronics of a frequency converter. Additionally or alternatively, one or more of the switching devices are integrated into power electronics, in a further embodiment, into power electronics of a frequency converter.

In one embodiment, this allows an active short circuit to be produced in a particularly advantageous manner, in particular safely, reliably, with low loss and/or a simple manner.

In one embodiment, one or more of the switching devices may also be external or separate devices, in particular in addition to power electronics and/or frequency converters for the corresponding electrical machine.

In one embodiment, this can increase safety and/or simplify retrofitting and/or maintenance.

In one embodiment, at least one of the switching devices in its second operating state causes an active short-circuit of an electric machine from a machine unit if the transmission gear of this machine unit has a malfunction and/or if the switching unit for interrupting the active connection between this transmission gear and the output has a malfunction, or is set up for this purpose.

In one embodiment, this can advantageously increase safety.

The present invention is particularly suitable for heavy duty applications. Accordingly, in one embodiment, the drive system is set up, particularly in terms of design and/or control, for at least temporary operation with a drive power of at least 0.5 megawatts (MW), preferably at least 1 MW, of the coupled machine. Particularly advantageous applications are mills, especially cement mills, wind turbines and PTI-PTO (PowerTakeln-PowerTakeOff) applications, without the present invention being limited thereto.

In one embodiment, during operation of the machine system, at least one of the switching units has its first operating state and, in the process, at least one other of the switching units first has its second operating state and then its first operating state. In other words, said at least one other switching unit closes when a switching unit is already closed, so that successively also the machine unit associated with this at least one other switching unit can (also) drive the output or be (also) driven by it. In this way, in one embodiment, additional machine units can advantageously be temporarily coupled as needed and thus, on the one hand, required drive power can be made available or electrical power can be converted as needed and, on the other hand, friction losses can be reduced beforehand and thus the operation, in particular the efficiency, of the drive system can be improved.

Additionally or alternatively, in one embodiment, during operation of the drive or machine system, at least one of the switching units has its second operating state and, in this case, at least one other of the switching units first has its first operating state and then its second operating state. In other words, this at least one other switching unit opens when a switching unit is already open, so that successively the machine unit associated with this at least one other switching unit is also disconnected. In this way, in one embodiment, machine units that are no longer required can advantageously be temporarily uncoupled as needed and thus, on the one hand, required drive power can be made available or electrical power can be converted when required and, on the other hand, friction losses can subsequently be reduced and thus the operation, in particular the efficiency, of the drive system can be improved.

Additionally or alternatively, in one embodiment, during operation of the machine system, at least one of the switching devices has its first operating state and, in this case, at least one other of the switching devices first has its second operating state and then has its first operating state. Additionally or alternatively, in one embodiment, during operation of the drive or machine system, at least one of the switching devices has its second operating state and, in this case, at least one other of the switching devices first has its first operating state and then has its second operating state. As described above, in one embodiment the drive system can thereby be advantageously adapted to an operating state of the coupled machine and/or the drive system.

Additionally or alternatively, in one embodiment during operation of the machine system, at least one of the switching units has its first operating state, and in this case at least one of the switching devices first has its second operating state and then has its first operating state. Additionally or alternatively, in one embodiment during operation of the drive or machine system, at least one of the switching units has its second operating state and in this case at least one of the switching devices first has its first operating state and then its second operating state. In this way, in one embodiment, machine units can advantageously be switched on or off as required and thus, on the one hand, required drive power can be made available or electrical power can be converted when required and, on the other hand, losses can subsequently or previously be reduced and thus the operation, in particular the efficiency, of the drive system can be improved. Additionally or alternatively, safety can be advantageously increased in one embodiment.

In one embodiment, one or more, in particular all, steps of the method are fully or partially automated, in particular by the control system.

### BRIEF DESCRIPTION OF THE DRAWINGS

The accompanying drawings, which are incorporated in and constitute a part of this specification, illustrate exemplary embodiments of the invention and, together with a general description of the invention given above, and the detailed description given below, serve to explain the principles of the invention.

FIG. 1 schematically illustrates an exemplary machine system having a drive system according to one embodiment of the present invention;

FIG. 2 schematically depicts the machine system with the drive system in axial view and corresponding to section line II-II in FIG. 1; and

FIG. 3 illustrates a method of operating the machine system according to one embodiment of the present invention.

### DETAILED DESCRIPTION

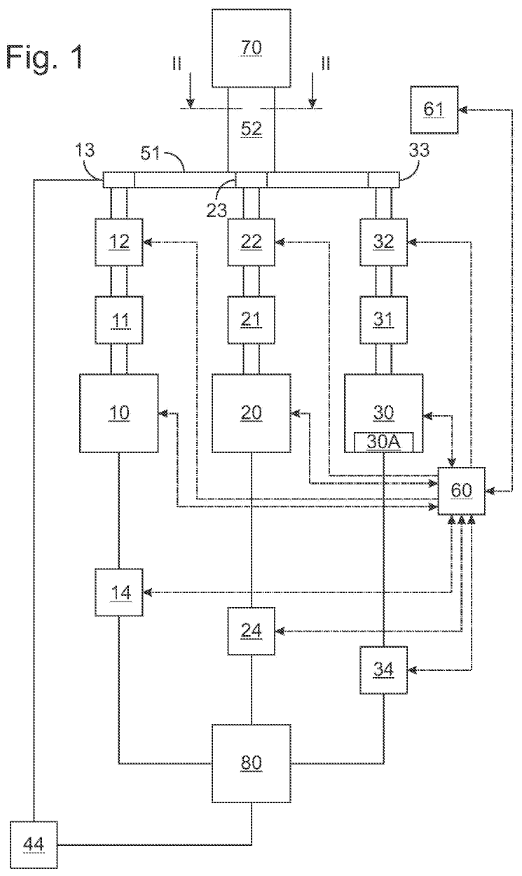

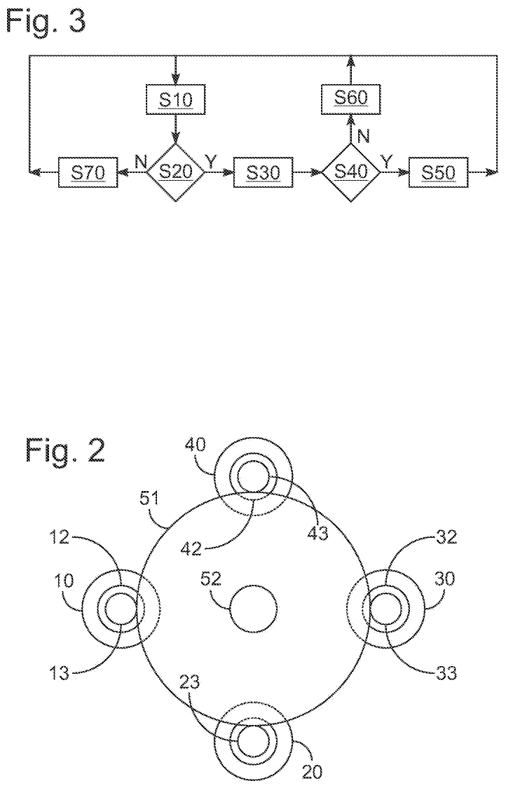

FIGS. 1, 2 show a machine system with a drive system according to one embodiment of the present invention in plan view (FIG. 1) and axial view (FIG. 2), respectively.

The machine system comprises a coupled machine 70 and the drive system.

In one embodiment, the coupled machine 70 may be a working machine or a prime mover or, in one embodiment, may be operated or function alternately temporarily as a working machine and temporarily as a prime mover. In the following, the invention will be explained in particular with reference to the example of a coupled working machine, but without being limited thereto.

The drive system comprises an output having a (collector) gear 51 and an output shaft 52 for driving the coupled machine(s) 70. In variations not shown, the output may also include a multi-stage gear.

The drive system comprises, by way of example, four machine units, each with an electric machine 10, 20, 30 and 40, respectively, and a transmission gearbox 11, 21, 31 (the fourth transmission gearbox is concealed in the views of FIGS. 1, 2) that can be driven by or drives them, as well as four switching units 12, 22, 32 and 42, respectively.

On the output side, the switching units are coupled to the gearwheel 51 via pinions 13, 23, 33 and 43, respectively, wherein in one embodiment the pinions are permanently in engagement with the gearwheel 51 and the switching units 12, 22, 32, 42 each have at least one freewheel or each have at least one selectively shiftable clutch, in particular can consist thereof. In one variation, the pinions 13, 23, 33, 43 can be selectively engaged with and disengaged from the gear wheel 51 by means of the corresponding(associated) switching units. Similarly, mixed forms are also possible in which the switching units 12, 22, 32, 42 are designed differently, for example two switching units comprise freewheels and two selectively shiftable couplings or the like.

Additionally, in the embodiment example, for each of the electric machines 10, 20, 30 and 40, respectively, a switching device 14, 24, 34 and 44, respectively, is provided, by means of which, in a first operating state of the corresponding switching device, the associated electric machine and a power supply and/or energy storage device 80 are or become electrically connected (i.e. (i.e. 8014-10; 8024-20; 8034-40; 8044-40) and, in a second operating state of the corresponding switching device, this connection to the power supply and/or energy storage device 80 is/are disconnected and an active short circuit of the associated electrical machine is/are effected.

A controller 60 receives information about the state of the machine system, in one embodiment of the drive system, from one or more sensors, one sensor 61 of which is indicated by way of example. Based on this sensor-detected state, the control 60 controls the electric machines 10, 20, 30, 40 and, if applicable, the optionally switchable clutches or the shifting of the pinions 13, 23, 33 or 43 into or out of engagement with the gear 51, which is indicated by dash-dotted lines in FIG. 1. Additionally, the control 60 controls the switching devices, which is also indicated by dashed dots in FIG. 1.

FIG. 3 shows a method of operating the machine system according to one embodiment of the present invention, initially focusing on the first aspect and a motorized operation or a working machine 70.

In a step S10, the electric machines 10 and 40, if necessary further, are energized and the switching units 12, 42 are brought into their first operating state or held there, so that by means of these switching units 12, 42 the transmission gear 11 coupled to the electric machine 10 and the transmission gear coupled to the electric machine 40 and concealed in the views of FIGS. 1, 2 are operatively connected in a torque-transmitting manner to the (gear 51 of the) output drive(s).

If in step S20 a corresponding state of the machine or drive system is detected (S20: “Y”), for example a drive power requirement exceeding a first limit value or the like, the electric machine 20 is, if necessary further, energized and the switching units 22 are brought into their first operating state or held there, so that by means of this switching unit 22 the transmission gear 21 coupled to the electric machine 20 is operatively connected in a torque-transmitting manner to the (gear 51 of the) output drive(s) (step S30).

If a corresponding state of the machine or drive system is detected in step S40 (S40: “Y”), for example a drive power requirement which also exceeds a higher second limit value, or the like, the electric machine 30 is also energized, if necessary further, and the switching unit 32 is brought into its first operating state or held there, so that by means of this switching unit 32 the transmission gear 31 coupled to the electric machine 30 is operatively connected to the (gear 51 of the) output drive(s) in a torque-transmitting manner (step S50).

Thus, all four switching units are in their first operating state and the gear 51 or the coupled machine 70 are driven in common by the four energized electric machines 10, 20, 30, 40.

The procedure then returns to step S10.

If in step S40 a corresponding state of the machine or drive system is detected (S40: “N”), for example a drive power requirement which exceeds the first limit value but not the higher second limit value, the electric machine 30 is not energized, or if necessary no longer energized, and the switching unit 32 is brought into its second operating state or held there, so that by means of this switching unit 32 the above-mentioned operative connection between the transmission gear 31 and the (gear 51 of the) output drive(s) is interrupted (step S60).

Thus, all switching units except the third switching unit 32 are in their first operating state and the gear 51 or the coupled machine 70 are driven (only) by the three electric machines 10, 20, 40 in common.

The procedure then returns to step S10.

If in step S20 a corresponding state of the machine or drive system is detected (S20: “N”), for example a drive power requirement which also does not exceed the first limit value, the electrical machine 20 is not energized, or if necessary no longer energized, and the switching unit 22 is brought into its second operating state or held there, so that by means of this switching unit 22 the above-mentioned operative connection between the transmission gear 21 and the (gear 51 of the) output drive(s) is interrupted (step S70).

Thus, all switching units except the second and third switching units 22, 32 are in their first operating state and the gear 51 or the coupled machine 70 are (only) driven jointly by the two electric machines 10, 40.

The procedure then returns to step S10.

The above embodiment example serves to illustrate a successive coupling or decoupling of the second machine unit 20, 21 and further machine unit 30, 31 for realizing a full-load operating state (cf. FIG. 3: S50), a first partial-load operating state (cf. FIG. 3: S30) and a second partial-load operating state (cf. FIG. 3: S70) by means of a simple example. Although exemplary embodiments have been explained in the preceding description, it should be noted that a large number of variations are possible.

In particular, analogous to the above and following explanation, the coupled machine 70 can also be a prime mover or alternately be operated or function temporarily as a working machine and temporarily as a prime mover. Also then, in the manner described above and below, one or more of the electric machines or machine units can be successively coupled or uncoupled and/or connected or actively short-circuited to the power supply.

Additionally or alternatively to decoupling by means of the switching units as described by way of example above, the controller 60 may analogously actively short-circuit one or more of the electrical machines by the switching device(s) associated with the respective electrical machine by (re)switching corresponding switching device(s) from its first to its second operating state. Conversely, additionally or alternatively to coupling by means of the switching units, the controller 60 may analogously electrically (re)connect one or more of the electrical machines to the power supply and/or energy storage device 80 through the switching device(s) associated with the respective electrical machine by (re)switching corresponding switching device(s) from its second to its first operating state.

For example, in the variation described below, the switching units 12, 22, 32, 42 may all remain in their respective first operating states or may be omitted and, in step S10, the electrical machines 10 and 40 may, if necessary, continue to be energized via the respective switching devices 14, 44 in their first operating states.

If a corresponding state of the machine system or drive system is detected in step S20 (S20: “Y”), for example a drive power requirement exceeding a first limit value or the like, the electric machine 20 is also energized via its associated switching device 24, if necessary further, and for this purpose the switching devices 24 are brought into their first operating state or held there (step S30).

If a corresponding state of the machine system or drive system is detected in step S40 (S40: “Y”), for example a drive power requirement which also exceeds a higher second limit value, or the like, the electric machine 30 is also energized via the switching device 34 assigned to it, if necessary further, and for this purpose the switching device 34 is brought into its first operating state or held there (step S50).

Thus, all four switching devices are in their first operating state and the gear 51 or the coupled machine 70 are driven jointly by the four energized electric machines 10, 20, 30, 40.

The procedure then returns to step S10.

If a corresponding state of the machine or drive system is detected in step S40 (S40: “N”), for example a drive power requirement which exceeds the first limit value but not the higher second limit value, the electric machine 30 is not energized, if necessary no longer, and for this purpose the switching device 34 is brought into its second operating state or held there, so that the electric machine 30 is or becomes actively short-circuited by this switching device 34 (step S60). Provided that it continues to be connected to the output in a torque-transmitting manner, since, for example, the switching unit 32 is not present or is in its first operating state, it is advantageously dragged along with low losses. Exemplary terminals 30A of the electric machine 30 are indicated in FIG. 1 for this purpose, which are short-circuited by the switching device 34 to thereby cause an active short-circuit of this electric machine.

Thus, all switching devices except the third switching device 34 are in their first operating state and the gear 51 or the coupled machine 70 are (only) driven jointly by the three electric machines 10, 20, 40.

The procedure then returns to step S10.

If a corresponding state of the machine or drive system is detected in step S20 (S20: “N”), for example a drive power requirement which also does not exceed the first limit value, the electrical machine 20 is not energized, or possibly no longer energized, and for this purpose the switching device 24 is brought into its second operating state or held there, so that the electrical machine 20 is or becomes actively short-circuited by this switching device 24 (step S70). If it continues to be connected to the output in a torque-transmitting manner, since, for example, the switching unit 22 is not present or is in its first operating state, it is advantageously dragged along with low losses.

Thus, all switching devices except the second and third switching devices 24, 34 are in their first operating state and the gear 51 or the coupled machine 70 are (only) driven jointly by the two electric machines 10, 40.

The procedure then returns to step S10.

Just as one or more, in particular all, switching devices can be omitted above for the embodiment in which (only) the switching devices are switched, conversely one or more, in particular all, switching units can be omitted for the embodiments explained at the beginning in which (only) the switching units are switched. Thus, in particular, in FIGS. 1, 2 one or more of the elements 12, 22, 32 and/or 42 and/or one or more of the elements 14, 24, 34 and/or 44 can be omitted.

In an embodiment, the two aspects explained above may also be or become combined.

Thus, for one or more of the machine units, both a switching unit and a switching device can be provided and used, in particular by actively short-circuiting the corresponding electric machine by means of the switching device in addition to an, in particular attempted, interruption of the torque-transmitting active connection of the transmission gear. In this way, safety can be increased in one embodiment.

Additionally or alternatively, only one switching unit can be provided and used for one or more of the machine units and only one switching device can be provided and used for one or more other of the machine units, so that the electrical machines are either actively short-circuited by corresponding switching devices or the torque-transmitting active connection of the associated transmission gear is interrupted by the corresponding switching unit, in particular when they are not required. In this way, it is advantageous, for example, to be able to “switch off” electrical machines that are differently constructed and/or used in different ways.

It should be noted that the exemplary embodiments are merely examples which are not intended to limit the scope of protection, the applications and the structure in any way. Rather, the preceding description provides the person skilled in the art with a guideline for the implementation of at least one exemplary embodiment, whereby various modifications, in particular with regard to the function and arrangement of the components described, can be made without leaving the scope of protection as it results from the claims and these equivalent combinations of features.

While the present invention has been illustrated by a description of various embodiments, and while these embodiments have been described in considerable detail, it is not intended to restrict or in any way limit the scope of the appended claims to such de-tail. The various features shown and described herein may be used alone or in any combination. Additional advantages and modifications will readily appear to those skilled in the art. The invention in its broader aspects is therefore not limited to the specific details, representative apparatus and method, and illustrative example shown and described. Accordingly, departures may be made from such details without departing from the spirit and scope of the general inventive concept.

### LIST OF REFERENCE SIGNS

10; 20; 30; 40 Electric machine
30A Connection terminals
11; 21; 31 Transmission gearbox
12; 22; 32; 42 Switching unit
13; 23; 33; 43 Pinion
14; 24; 34; 44 Switching device
51 Gear
52 Output shaft
60 Control
61 Sensor
70 coupled machine
80 Power supply and/or energy storage device

What is claimed is:

1-17. (canceled)

18. A drive system for driving or being driven by a machine coupled with the drive system, the drive system comprising:
an output configured for at least one of driving or being driven by the coupled machine;
a first machine unit comprising at least one first electric machine for at least one of driving or being driven by the output; and
a second machine unit comprising at least one second electric machine for at least one of driving or being driven by the output;
wherein at least one of:
a) the first machine unit comprises a transmission gear arranged to at least one of be driven by the first electric machine or to drive the first electric machine, and the drive system comprises a first switching device configured such that:
in a first operating state of the first switching device, the transmission gear of the first machine unit and the output are operatively mechanically connected in a torque-transmitting manner, and
in a second operating state of the first switching device, the operative connection between the transmission gear of the first machine unit and the output is interrupted; or
b) the drive system has a second switching device configured such that:
in a first operating state of the second switching device, one of the first or second electric machines and at least one of a power supply or an energy storage device are electrically connected, and
in a second operating state of the second switching device, the connection to the at least one of a power supply or an energy storage device is electrically disconnected and an active short-circuit of the first or second electric machines is effected.

19. The drive system of claim 18, wherein at least one of:
a) the second machine unit comprises a transmission gear adapted to at least one of be driven by the second electric machine or to drive the second electric machine, and the drive system comprises a third switching device configured such that:
in a first operating state of the third switching device, the transmission gear of the second machine unit and the output are operatively connected in a torque-transmitting manner, and
in a second operating state of the third switching device, the operative connection between the transmission gear of the second machine unit and the output is interrupted; or
b) the drive system comprises a fourth switching device configured such that:
in a first operating state of the fourth switching device, the other of the first or second electric machines is electrically connected with at least one of a power supply or an energy storage device, and
in a second operating state of the fourth switching device, the connection to the at least one of a power supply or energy storage device is disconnected and an active short-circuit of the other of the first or second electrical machines is effected.

20. The drive system of claim 19, wherein the drive system is configured such that at least one of:
A) in at least one operating state of the drive system, the first switching device has its first operating state and the second switching device has its first operating state, and
in at least one other operating state of the drive system:
the first switching device has its second operating state and the second switching device has its first operating state, or
the first switching device has its first operating state and the second switching device has its second operating state, or
the first switching device has its second operating state and the second switching device has its second operating state;
B) in at least one operating state of the drive system, the first switching device has its first operating state and the third switching device has its first operating state, and
in at least one other operating state of the drive system:
the first switching device has its second operating state and the fourth switching device has its first operating state, or
the first switching device has its first operating state and the fourth switching device has its second operating state; or
the first switching device has its second operating state and the fourth switching device has its second operating state: or
C) in at least one operating state of the drive system, the second switching device has its first operating state and the fourth switching device has its first operating state, and
in at least one other operating state of the drive system:
the second switching device has its second operating state and the fourth switching device has its first operating state, or
the second switching device has its first operating state and the fourth switching device has its second operating state, or
the second switching device has its second operating state and the fourth switching device has its second operating state.

21. The drive system of claim 19, wherein at least one of the first or third switching devices has at least one freewheel.

22. The drive system of claim 19, wherein at least one of the first or third switching devices has at least one selectively switchable clutch.

23. The drive system of claim 19, wherein at least one of:
at least one of the transmission gears and/or the output comprises at least one of:
at least one spur gear, or
at least one planetary gear: or
at least one of the transmission gears and/or the output is configured such that an input speed of the coupled electric machine is converted into either a smaller output speed or a larger output speed on the output side.

24. The drive system of claim 19, wherein at least one of the second or fourth switching devices in the second operating state is adapted to short-circuit terminals of the respective electric machine, thereby causing an active short-circuit of the electric machine.

25. The drive system of claim 19, wherein at least one of the second or fourth switching devices comprises power electronics, in particular of a frequency converter, or is integrated into power electronics.

26. The drive system of claim 19, wherein at least one of the second or fourth switching devices in the second operating state is arranged to cause an active short-circuit of an electric machine from a machine unit in response to at least one of:
the transmission gear of the respective machine unit has a malfunction; or
the first or third switching device for interrupting the active connection between the transmission gear of the respective machine unit and the output has a malfunction.

27. The drive system claim 19, further comprising a controller configured for at least one of:
controlling at least one of the electrical machines;
switching at least one of the switchable couplings; or
switching at least one of the switching devices.

28. The drive system of claim 27, wherein at least one of:
controlling at least one of the electrical machines comprises controlling on the basis of a state of at least one of the drive system or the coupled machine; or
switching at least one of the switchable couplings or switching devices comprises switching on the basis of a state of at least one of the drive system or the coupled machine.

29. The drive system of claim 28, wherein the state of at least one of the drive system or the coupled machine is detected by sensors.

30. The drive system of claim 19, wherein the drive system is adapted to operate with a drive power of the coupled machine of at least 0.5 MW.

31. A machine system, comprising:
a drive system according to claim 18; and
a machine coupled with the drive system such that the machine at least one of drives the drive system, or is driven by the drive system.

32. The machine system of claim 31, wherein the machine drives the drive system, or is driven by the drive system, with a drive power of at least 0.5 MW.

33. A method of operating a machine system, the method comprising:
obtaining a machine system according to claim 31; and
at least one of:
jointly driving the output with at least the first electric machine and the second electric machine in a motor operating state of the drive system, wherein at least one of the first switching device or the second switching device is in the first operating state; or
jointly driving at least the first electric machine and the second electric machine with the output in a generator operating state of the drive system, wherein at least one of the first switching device or the second switching device is in the first operating state.

34. The method of claim 33, wherein at least one of:
the motor operating state of the drive system is a full-load operating state;
in the motor operating state of the drive system, the output is further driven by an electric machine of a further machine unit, jointly with the first electric machine and the second electric machine;
the generator operating state of the drive system is a full-load operating state; or
in the generator operating state of the drive system, the electric machine of the further machine unit is further driven by the output, jointly with the first electric machine and the second electric machine.

35. The method of claim 33, further comprising at least one of:
switching from a first motor operating state to a second, different motor operating state of the drive system, wherein at least one of the machine units continues to drive the output, by at least one of a) transferring at least one of the first or third switching devices from the first operating state to the second operating state, or b) transferring at least one of the second or fourth switching devices from the first operating state to the second operating state; or
switching from a first generator operating state to a second, different generator operating state of the drive system, wherein at least one machine unit is driven by the output, by at least one of a) transferring at least one of the first or third switching devices from the first operating state to the second operating state, or b) transferring at least one of the second or fourth switching devices from the first operating state to the second operating state.

36. The method of claim 35, wherein at least one of the second motor operating state or the second generator operating state is a partial load operating state.

37. The method of claim 33, wherein at least one of:
at least one of the electrical machines is controlled on the basis of at least one of a state of the drive system or a state of the coupled machine;
at least one of the switchable couplings is switched on the basis of at least one of a state of the drive system or a state of the coupled machine; or
at least one of the switching devices is switched on the basis of at least one of a state of the drive system or a state of the coupled machine.
